(19) United States
(12) Patent Application Publication
(10) Pub. No.: US 2018/0197651 A1
(43) Pub. Date: Jul. 12, 2018

(54) ELECTRICAL CONDUCTORS HAVING INCREASED CURRENT CARRYING CAPACITY

(71) Applicant: General Cable Technologies Corporation, Highland Heights, KY (US)

(72) Inventors: Carlos Augusto Ospina Ramirez, Bogota (CO); Jared D. Weitzel, Cincinnati, OH (US)

(21) Appl. No.: 15/866,614

(22) Filed: Jan. 10, 2018

Related U.S. Application Data
(60) Provisional application No. 62/444,448, filed on Jan. 10, 2017.

(51) Int. Cl. H01B 1/02; H01B 5/10

(52) U.S. Cl. CPC H01B 1/023; H01B 5/104

(57) ABSTRACT

A cable includes a conductor core having a periphery. The conductor core includes a plurality of core wires and a plurality of conductive fillers. The plurality of conductive fillers partially define the periphery of the conductor core. A plurality of conductors are peripherally positioned around the conductor core.

### REFERENCE TO RELATED APPLICATIONS

The present application claims the priority benefit of U.S. provisional application Ser. No. 62/444,448, entitled ELECTRICAL CONDUCTORS HAVING INCREASED CURRENT CARRYING CAPACITY, filed Jan. 10, 2017, and hereby incorporates the same application herein by reference in its entirety.

### TECHNICAL FIELD

The present disclosure relates to electrical conductors, such as a high voltage overhead electricity transmission lines.

### BACKGROUND

As the need for electricity continues to grow, the need for transmission and distribution lines with higher current carrying capacity grows as well. The amount of power an overhead electricity transmission line can deliver is dependent on the current-carrying capacity (ampacity) of the line. Overhead electricity transmission lines can be formed in a variety of configurations. Some configurations include a highly conductive core formed of one or more wires such as aluminum alloy. These include conductors are referred to as all aluminum conductor (“AAC”), all aluminum alloy conductor (“AAAC”), and the like. Other configurations include a low or non-conducting core such as steel or carbon fiber composites. These include conductors referred to as aluminum conductor steel reinforced (“ACSR”), aluminum conductor steel supported (“ACSS”), aluminum conductor composite core (“ACCC”), and the like. ACSR, ACSS, ACCC, and AAAC cables, among others, can be used as overhead cables for overhead distribution and transmission lines. While such cables can have an overall high tensile strength, there remains a need to increase the conductivity of the line to increase its current-carrying capacity.

### BRIEF DESCRIPTION OF THE DRAWINGS

FIG. 1 is a cross sectional view of an example core according to one embodiment, prior to a compaction process;

FIG. 2 illustrates the core of FIG. 1 subsequent to an example compaction process;

FIG. 3 illustrates the core of FIG. 2 surrounded by conductive wires to form a composite conductor, according to one embodiment;

FIG. 4 depicts another composite conductor according to one embodiment; and

FIG. 5 is a photograph of a cross section of an example composite conductor having conductive fillers, according to one embodiment.

### DETAILED DESCRIPTION

The present disclosure provides a core for composite conductors which have increased conductivity. When the core is combined with conductor wires to form a composite conductor, the current-carrying capacity of the composite conductor can be increased. Example composite conductors include, without limitation, overhead electricity transmission lines. Methods for manufacturing cores having increased conductivity are also disclosed.

The present disclosure can be applicable to a wide array of interstitial filler materials, core materials, and conductor materials, which may be used in a variety of conductor types, such as ACSR, ACSS, ACCC, and AAAC cables, for instance. In certain embodiments, the core, interstitial fillers, and conductor include solid or stranded round wires. In other embodiments, the core, interstitial fillers, and conductor include stranded shaped wires. Further, the core, interstitial fillers, and conductor can be formed from any suitable material, such as steel, steel coated with zinc, steel coated with aluminum, aluminum, aluminum alloy, aluminum composite, copper, carbon fiber composite, plastic, or other materials known to those familiar in the art.

In accordance with the present disclosure, conductive fillers can be stranded over the core or otherwise embedded in the core. Once the core is combined with conductors to form an overhead electricity transmission line or other type of conductor, the conductive filler of the core serves to beneficially increase the cross sectional area of the conductive section of the composite conductor. The amount of increase of the conductive section provided by the conductive fillers can depend on the size and construction of the composite conductor, as described in more detail below.

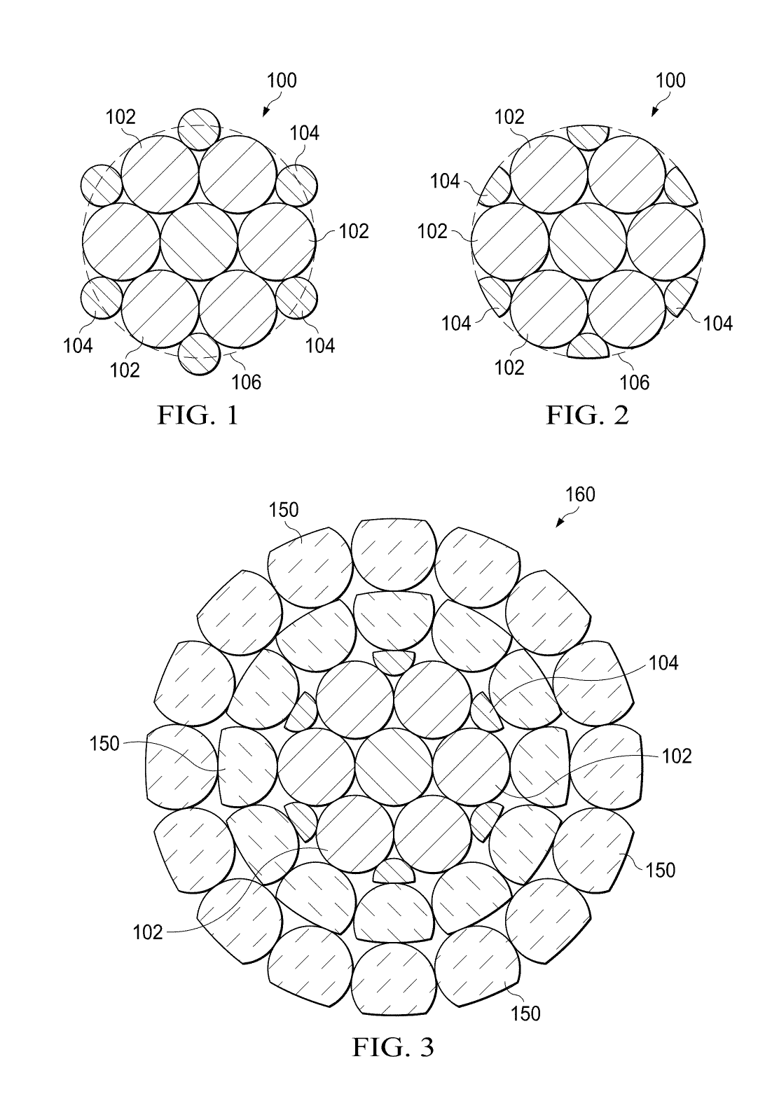

FIG. 1 is a cross sectional view of an example conductor core 100 according to one embodiment, prior to a compaction process. FIG. 2 illustrates the conductor core 100 subsequent to an example compaction process. FIG. 3 illustrates the conductor core 100 of FIG. 2 surrounded by conductive wires 150 to form a complete conductor 160, according to one embodiment. The complete conductor 160 can be, for instance, a high voltage overhead electricity transmission line.

Referring first to FIG. 1, the conductor core 100 can be a multi-wire core, having a plurality of core wires 102. In the illustrated embodiment, the conductor core 100 has seven coated steel strands, although this disclosure is not so limited. The diameters of the individual core wires 102 can vary. In certain embodiments, the diameter of the core wires 102 can be in the range of about 1 mm to about 5 mm, for example. Adjacent core wires 102 define interstices that are positioned around the periphery of the conductor core 100, with six interstices being defined by the conductor core 100 illustrated in FIG. 1, as well as positioned between internal layers of the conductor core. The cross sectional area of the interstices can vary based on the size of the core wires 102. For instance, a set of core wires 102 having relatively large diameters can define interstices having a larger cross sectional area than a set of core wires 102 having a relatively small diameter.

In accordance with the present disclosure, at least portions of conductive fillers 104 can be stranded into each of the interstices. The diameter of the conductive filler 104 can be selected based on the size of the interstices. As shown, for instance, the conductive filler 104 can be sized such that an inner portion of the conductive fillers 104 is received into the interstices, while an outer portion of the conductive fillers radially extends past a core circumference (shown by dashed line 106), as defined by the outer periphery of the core wires 102. While round conductive fillers 104 are depicted in FIG. 1, in other embodiments, the conductive fillers 104 can have other shapes, such as a trapezoidal or semi-circle shape.

Referring now to FIG. 2, the conductor core 100 is depicted subsequent to an example compaction process. The compaction process can be performed using dies, among other suitable processes. As shown, the compaction process deforms the conductive fillers 104, such that they generally fill the interstices between adjacent core wires 102. The deformation of the conductive fillers 104 can serve to make the conductor core 100 substantially round, which can beneficially provide a better surface for placing conductors around the conductor core 100 and can limit deformation of the inner ring of conductors that are in direct contact with the conductor core 100.

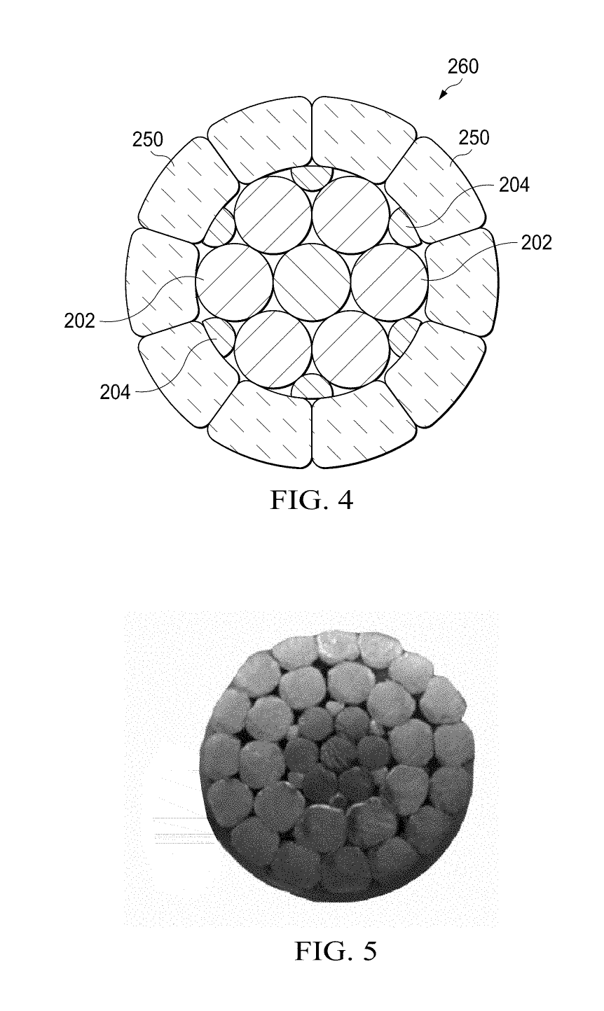

Referring now to FIG. 3, an example complete conductor 160 is shown which includes highly conductive wires 150 that surround the low conductive core 100 with the deformed conductive fillers 104. The conductive wires 150 of the complete conductor 160 are shown to be compacted, as may be required. Further, in the illustrated embodiment, each layer of conductive wires 150 was sequentially compacted upon being applied to the conductor core 100, although this disclosure is not so limited. While round conductive wires 150 are depicted, other wire shapes can be used, such as trapezoidal conductive wires, an example of which is depicted in FIG. 4, below.

Beneficially, due to the conductive fillers 104 being positioned between adjacent core wires 102, the deformation of the inner layer of the conductive wires 150 (for either round or trapezoidal wires) may be reduced, as the conductive fillers 104 can generally fill the voids between the core wires 102. Additionally, the conductive fillers 104 increase the cross sectional area of conductivity, which can increase the overall current carrying capacity of the complete conductor 160.

While the conductive fillers 104 in FIG. 3 are positioned between the core wires 102 and the conductive wires 150, this disclosure is not so limited. Instead, conductive fillers 104 can be placed in any layer of the complete conductor 160, including layers of the conductor core 100 and layers of the conductive wires 150. Further, while FIGS. 1-3 depict the conductive fillers 104 being compacted prior to the conductive wires 150 being stranded around the conductor core 100, other manufacturing processes can be utilized. For instance, in certain embodiments, the conductive fillers 104 are fed into the interstices of the core wires 102, and at least some of the conductive wires 150 are placed around the core wires 102 and the conductive fillers 104. The assembly is then compacted, with the conductive fillers 104 deforming into the interstices during compaction.

FIG. 4 depicts another composite conductor 260 that includes core wires 202 surrounded by conductive wires 250 subsequent to a compaction process. In this embodiment, conductive wires 250 are trapezoidal shaped wire. Conductive fillers 204 are positioned in the interstices between adjacent core wires 202 such that distortion of the conductive wires 250 during the compaction process may be reduced.

FIG. 5 is a photograph of a cross section of an example composite conductor having 26 conductive wires, six conductive fillers, and seven core wires in accordance with one embodiment.

The use of conductive fillers according to the present disclosure can provide additional current carrying capacity to conductors. Table 1 identifies example increased conductivity for example composite conductors having aluminum wires (i.e., conductive wires 150) and a steel core (i.e., core wires 102):

TABLE 1

| Number of | | Number of | Percentage |
|---|---|---|---|
| Conductive | Number of | Conductive | increase of |
| Wires | Core Wires | Fillers | conductive cross- |
| (Aluminum) | (Steel) | (Aluminum) | sectional area |
| 26 | 7 | 6 | 2.5% |
| 24 | 7 | 6 | 2.0% |
| 30 | 7 | 6 | 3.5% |
| 12 | 7 | 6 | 8.3% |

Table 2 identifies example construction dimensions with interstice space available for fillers:

TABLE 2

| Number of | Steel Core | | 7 | 7 | 7 | 7 | 7 |
|---|---|---|---|---|---|---|---|
| Strands | Conductor | | 12 | 30 | 26 | 24 | 26 |
| Strand | Steel Core | mm | 3.00 | 3.00 | 2.30 | 2.00 | 2.00 |
| Diameter | Conductor | mm | 3.00 | 3.00 | 3.00 | 3.00 | 2.57 |

| | | | | | | |
|---|---|---|---|---|---|---|
| Interstice space available | mm² | 12.0 | 12.0 | 7.0 | 5.3 | 5.3 |
| Conductor cross sectional area | mm² | 84.8 | 212.1 | 183.8 | 169.6 | 135.2 |
| Interstice space available in | % | 14.1% | 5.6% | 3.8% | 3.1% | 3.9% |
| conductor core | | | | | | |
| Diameter strand before stranding | mm | 1.43 | 1.43 | 1.10 | 0.96 | 0.96 |
| and compacting | | | | | | |

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A cable, comprising:
a conductor core having a periphery, wherein the conductor core comprises:
a plurality of core wires;
a plurality of conductive fillers, wherein the plurality of conductive fillers partially define the periphery of the conductor core; and
a plurality of conductors peripherally positioned around the conductor core.

2. The cable of claim 1, wherein the plurality of core wires define interstices between adjacent core wires, and wherein one of the plurality of conductive fillers is positioned within each of the interstices.

3. The cable of claim 2, wherein the plurality of conductive fillers are deformable by a compaction process.

4. The cable of claim 3, wherein each of the plurality of conductive filters has a substantially circular cross-sectional shape prior to the compaction process.

5. The cable of claim 1, wherein the plurality of conductors comprises a plurality of layers, wherein the plurality of layers comprises an inner layer, wherein the conductors of the inner layer are positioned directly against the conductor core, wherein at least one of the conductors of the inner layer is in contact with at least one of the plurality of conductive fillers.

6. The cable of claim 5, wherein each of the plurality of conductive fillers is in contact with one or more conductors of the inner layer.

7. The cable of claim 1, wherein each of the plurality of conductors has a trapezoidal cross-sectional shape.

8. The cable of claim 1, wherein each of plurality of core wires is steel, each of the plurality of conductive fillers is aluminum, and each of the plurality of conductors is aluminum.

9. The cable of claim 8, wherein the conductor core comprises seven core wires and six conductive fillers.

10. The cable of claim 9, wherein, prior to any compaction, each of the core wires has a diameter of about 3 mm and each of the conductive fillers has a diameter of less than 2 mm.

11. The cable of claim 1, wherein adjacent conductors of the plurality of conductors define a conductor interstice, and wherein a conductive filler is positioned within the conductor interstice.

12. The cable of claim 11, wherein the plurality of conductors define a plurality of conductor interstices, and wherein a respective conductive filler is positioned in each of the respective plurality of conductor interstices.

13. A conductor core, comprising:
a plurality of core wires, wherein each of the plurality of core wires is steel and has a diameter of about 3 mm;
a plurality of conductive fillers, wherein each of the plurality of conductive fillers is aluminum and has a diameter of less than about 2 mm;
wherein the plurality of core wires form a bundle defining a plurality of interstices between adjacent core wires around a periphery of the bundle; and
wherein one of the plurality of conductive fillers is positioned with each of the plurality of interstices.

14. The conductor core of claim 13, comprising seven core wires and six conductive fillers.

15. The conductor core of claim 13, wherein each of the plurality of conductive fillers is deformable during a compaction process.

16. A method of forming an electrical cable, the method comprising:
forming a conductor core, wherein forming the conductor core comprises:
providing a plurality of core wires, wherein the plurality of core wires define interstices between adjacent core wires around a periphery of the plurality of core wires;
providing a plurality of conductive fillers, wherein each of the conductive fillers is positioned in a respective interstice between adjacent core wires;
compacting the plurality of conductive fillers;
subsequent to compacting the plurality of conductive fillers, peripherally positioning a plurality of conductors around the core, wherein one or more of the plurality of conductors are in contact with one or more of the plurality of conductive fillers.

17. The method of claim 16, wherein, the plurality of core conductors define a core circumference, and wherein, prior to compaction, each of the plurality of conductive fillers radially extends outward of the core circumference.

18. The method of claim 16, wherein the conductor core comprises seven core wires and six conductive fillers.

19. The method of claim 16, wherein each of the plurality of conductors has a trapezoidal cross-sectional shape.

20. The method of claim 16, wherein peripherally positioning the plurality of conductors around the core comprises positioning a conductive filler between adjacent conductors of the plurality of conductors.
